(19) United States
(12) Patent Application Publication
(10) Pub. No.: US 2002/0197445 A1
(43) Pub. Date: Dec. 26, 2002

(54) Loop pile fabric

(76) Inventors: David Eccles, Cheshire (GB); Rodney D. Finnen, Cheshire (GB)

Correspondence Address: DANN DORFMAN HERRELL & SKILLMAN, SUITE 720, 1601 MARKET STREET, PHILADELPHIA, PA, 19103-2307, US

(21) Appl. No.: 10/135,235

(22) Filed: Apr. 30, 2002

(30) Foreign Application Priority Data
Apr. 30, 2001 (GB) 0110487.6

(51) Int. Cl. B32B 3/02; D03D 27/00; D03D 27/08; B32B 33/00; D04H 11/00

(52) U.S. Cl. 428/97; 139/391; 139/396

(57) ABSTRACT

A pile towelling fabric having a ground structure from which a pile projects, the pile being formed from a yarn spun from a blend of staple fibres consisting of a combination of a first blend constituent comprising a moisture absorbent binding fibre and a second blend constituent including natural silk fibres.

### FIELD OF THE INVENTION

The present invention relates to a pile towelling fabric and products made from the towelling fabric.

### BACKGROUND OF THE INVENTION

Pile towelling fabrics are well known; they comprise a ground fabric which is covered on one or both of its faces with a projecting loop pile. The fabrics are normally woven and the pile forming yarn is normally a warp yarn.

The main function of a towelling fabric is to dry the skin of a user by rubbing the towelling fabric over the skin. This main function of a towelling fabric is referred to herein as the ‘towelling function’. The performance of the towelling function is primarily dependent upon two criteria; viz. the capability of the towelling fabric to physically remove droplets of water from the skin and the ability of the fabric to absorb the water which has been removed. Thus the greater the capability of being able to physically remove water droplets from the skin and the greater the capability to absorb water, then the higher the performance of the towelling function.

The capability of a towelling fabric to physically remove water droplets from the skin is dependent upon the degree to which the pile loops are upstanding and also the smoothness of the loop pile. In this respect, more upstanding loops are the better for ‘grabbing’ water droplets during rubbing of the towelling fabric over the skin. Also with regard to smoothness, the less smooth or slippy the pile loop the better. For instance, if the pile loops are too slippy, there is a tendency for the towelling fabric, when folded upon itself, to slide over itself rather than slide across the skin when a user attempts to rub the fabric over their skin. Thus if the loop pile is too slippy it detracts from the towelling function of the fabric.

A commonly used material for towelling fabrics is cotton. This is because cotton is sufficiently stiff to provide upstanding pile loops which are not too slippy and thereby provides a good capability for physically removing water droplets from the skin. In addition, cotton has good water absorbency characteristics. Thus, overall, a towelling fabric made from 100% cotton has a good towelling function.

It has been recognised by the present applicants that a certain market sector of users require a towelling fabric which has certain luxuriant qualities which render it highly desirable whilst having an underlying good absorbency function.

This market sector associates a natural silk content as rendering the towelling fabric as highly desirable. The greater the natural silk content, the greater the desirability.

The presence of a natural silk content in the towelling fabric is perceived by this market sector as providing the towelling fabric with certain qualities hereinafter referred to as ‘desirability qualities’.

Unfortunately, natural silk is not well suited for incorporation into a towelling fabric since, primarily due to its slippy nature, it detracts from the towelling function of the fabric. Thus, although the presence of a high natural silk content may contribute to the desirability quality of the towelling fabric, the higher the natural silk content the poorer the towelling function of the towelling fabric.

Also, the present applicants have recognised that the market sector referred to above associate a high lustrous appearance to be an indication of the amount of natural silk contained in the fabric. Thus an important desirability quality is the lustrous visual appearance of the towelling fabric, i.e. the degree of shine and shimmer of the fabric. The present applicants have recognised that for a towelling fabric, a dull appearance (as commonly associated with towelling fabrics made from 100% cotton) detracts from the desirability quality of the fabric.

### SUMMARY OF THE INVENTION

A general aim of the present invention is to provide a pile towelling fabric which incorporates a sufficiently high content of natural silk to give it a high desirability quality whilst retaining a good towelling function.

### DESCRIPTION OF THE PREFERRED EMBODIMENTS

According to one aspect of the present invention there is provided a pile towelling fabric having a ground fabric structure from which a pile projects, the pile being formed from a yarn spun from a blend of staple fibres consisting of a combination of a first blend constituent comprising a moisture absorbent binding fibre and a second blend constituent including natural silk fibres.

The binding fibre is preferably highly moisture absorbent and preferably comprises cotton. Any variety of cotton may be used.

Preferably the second blend constituent comprises natural silk only or a combination of natural silk fibres and fibres of a soft, lustrous material such as a regenerated cellulose, eg modal, the lustrous fibres preferably having a greater degree of luster than natural silk.

The natural silk content in the spun yarn preferably ranges between 1 to 50% by weight, more preferably between 5 to 30% by weight, and still more preferably 10 to 25% by weight of the spun yarn.

The presence of natural silk fibres in the second blend constituent of the spun yarn provides the towel fabric with a lustrous silky appearance, a ‘clingy’ or fluid drape, and/or additional moisture absorbency.

The presence of the lustrous fibres in the second blend constituent provides additional moisture absorbency for the spun yarn and contributes to the soft feel of the pile and the fluid drape of the fabric.

Preferably the regenerated cellulose fibre yarn is modal but other regenerated cellulose fibres such as Lyocell may be used. The modal may be micro modal having a dtex value of 1.0 or less; or alternatively may be a non-micro modal having a dtex value of about 1.5 dtex. Preferably the modal has a dtex value of 2 dtex or less. Micromodal is preferred as it increases the soft feel and improves the wicking capability of the pile yarn.

The lustrous fibre content is preferably between 20% to 40% by weight of the spun yarn, more preferably between 25 to 35% by weight of the spun yarn.

Preferably the second blend constituent constitutes 50% or more by weight of the spun yarn.

Preferably the percentage by weight of the first blend constituent in the spun yarn is chosen to ensure that sufficient binding fibres are present to anchor the natural silk fibres, and if provided, the lustrous fibres of the second blend constituent within the spun yarn.

In this respect the natural silk and lustrous fibres of the second blend constituent tend to be smooth and prone to shed from the spun yarn. The first blend constituent is preferably composed of fibres which readily interlock during spinning, i.e. the fibres extend in a twisted manner and/or are hairy. These fibres therefore tend to positively lock or bind to one another.

In the spun blended yarn of the present invention, the fibres of the first blend constituent interlock with the smooth natural silk and, if provided, the lustrous fibres of the second blend constituent and the quantity of the first blend constituent relative to the second blend constituent is chosen to be sufficiently great to ensure that the fibres of the second blend constituent are bound within the spun yarn.

Also the percentage weight of the first constituent in the spun pile yarn is preferably chosen to ensure that pile loops formed from the pile yarn are upstanding.

Preferably the pile is defined by pile loops. The loops preferably have a length which ranges between 10 to 20 mm, more preferably between 12 to 18 mm.

The ground fabric structure is preferably formed from a highly moisture absorbent yarn such as cotton in order to improve the overall moisture absorbent capability of the towel. It has been found that the spun yarn of the present invention exhibits good wicking capabilities and so ensures that moisture is transmitted to the ground fabric to be absorbed there.

Preferably the yarn count of the cotton used for forming the ground structure is chosen to be sufficiently fine so as not to cause the towelling fabric to stiffen to mask the drape qualities imparted by the looped pile.

Preferably the yarn count of cotton yarn used for forming the ground fabric is about 12 ne.

Preferably the yarn count of the spun pile forming yarn is about 16 ne.

Preferably the fabric is a woven fabric.

The blended yarn is preferably combed prior to spinning in order to give a softer, more lustrous yarn which also is less prone to short fibre shedding.

Specific examples of a pile fabric according to the present invention are given below:

Fabric Type: 3 pick terry weave

Blended Pile Yarn: Comb blend consisting of 48% by wt cotton/30% by wt micromodal and 22% by wt silk; yarn count of 16 ne

Ground Warp: Carded cotton; yarn count of 12 ne

Body Weft: Open end spun cotton; yarn count of 12 ne.

| | | | | | |
|---|---|---|---|---|---|
| Size (cms): | 33 × 33 | 50 × 76 | 50 × 100 | 75 × 137 | 90 × 178 |
| Weight/Unit (g): | 65.4 | 243 | 330 | 678 | 1024 |
| Weight/M² (g): | 600 | 640 | 660 | 660 | 640 |
| Ends/cm: | 26.9 | 27.2 | 27.2 | 27.2 | 26.9 |
| Reed: | 58 | 58 | 58 | 58 | 58 |
| Picks/cm: | 16.9 | 18.5 | 19.3 | 19.7 | 19.3 |
| Terry Ratio: | 8.15 | 9.95 | 10.4 | 10.6 | 10.4 |
| Loop Length | 14.4 | 16.1 | 16.2 | 16.2 | 16.2 |
| (mm): | | | | | |

In the above examples, the cotton constituent in the spun pile yarn provides moisture absorbency and binding of the modal and natural silk within the pile yarn. The modal constituent provides an increased rate of moisture absorbency due to its wicking capabilities, a soft feel and lustrous appearance. The silk constituent primarily provides durability, lustrous appearance and more fluid drape.

The pile yarn of the above example exhibits good wickability to transfer moisture to the ground fabric whereat moisture is also absorbed. Thus, overall, the entire towelling fabric (i.e. the ground fabric and pile loops) exhibits good water absorbency.

It has also been surprisingly found that in the above example the ‘towelling handle’ of the towelling fabric, i.e. the tactile nature of the towelling fabric when a user touches or rubs the pile surface, is improved over that of the towelling handle characteristics of the individual constituents. This is perceived by the user to reflect the presence of natural silk within the fabric and so markedly improve its desirability quality.

In this respect, the towelling handle of a pile towelling fabric having pile made from 100% cotton has a soft feel due to the bulky nature of cotton but tends to feel harsh when rubbed due to the cotton defining relatively hard/stiff upstanding pile loops.

A towelling fabric having pile made from 100% natural silk fibres has a hard feel due to the lack of bulk provided by natural silk fibres and tends to feel slippy and damp when rubbed. The pile loops are upstanding (to a lesser degree than with cotton) and due to the rigid/stiff nature of natural silk fibres the individual pile loops can be felt (likened to rubbing fingers along bristles).

A towelling fabric made from 100% modal also feels hard due to the lack of bulk and again feels slippy and damp when rubbed. The pile loops also lie flat and so also contribute to a hard feel when the pile is rubbed.

By contrast, a pile towelling fabric formed from a blended spun yarn having 48% by weight cotton, 22% by weight natural silk fibres and 30% by weight modal, exhibits excellent towelling handle in that the pile yarn produces a pile having upstanding loops and a bulked pile which is soft to the touch and also has a soft feel when rubbed.

It is to be appreciated that a reduction or increase in the relative proportions of the cotton, natural silk and modal fibres in the first and second constituents in the yarn will have differing effects on the towelling function of the towelling fabric, its visual appearance and its towelling handle.

Thus a pile yarn according to the present invention may have a relatively low natural silk and modal content but still provide a towelling fabric having superior desirability qualities (than a towelling fabric made of say 100% cotton) by improving the towelling handle and visual appearance of the towelling fabric.

For instance, such a towelling fabric may be provided by forming the pile loops from a spun yarn having about 80% by weight of cotton, 10% by weight of natural silk and 10% by weight of modal.

As indicated above, the provision of the lustrous fibres in the second constituent improves the visual appearance of the towelling fabric in that it gives the fabric a higher degree of luster than that possible with cotton and natural silk only and in addition provides a softer feel to the blended yarn than that felt when the spun yarn comprises cotton and natural silk only.

However, it is envisaged that, although preferred, the presence of the lustrous fibres in the second constituent is optional. In this respect, a pile yarn spun from a blend of cotton and natural silk fibres still provides improved towelling handle and improved visual appearance than when compared to a pile yarn formed from either cotton or natural silk alone. In this respect it is envisaged that to achieve the benefits of towelling handle and visual appearance, the natural silk content may range between 1 to 50% by weight of the yarn whilst the remainder of the yarn is made up of cotton.

The pile towelling fabric of the present invention is particularly useful for making into towels of any size and for being made into garments such as bathrobes.

1. A pile towelling fabric having a ground structure from which a pile projects, the pile being formed from a yarn spun from a blend of staple fibres consisting of a combination of a first blend constituent comprising a moisture absorbent binding fibre and a second blend constituent including natural silk fibres.

2. A pile fabric according to claim 1 wherein the binding fibre comprises cotton.

3. A pile fabric according to claim 1 or 2 wherein the second blend constituent constitutes 50% or more by weight of the spun yarn.

4. A pile fabric according to claim 1, 2 or 3 wherein the second blend constituent comprises a combination of natural silk and fibres of a lustrous material.

5. A pile fabric according to claim 4 wherein the lustrous fibres are made from a regenerated cellulose.

6. A pile fabric according to claim 4 or 5 when dependent on claim 1 or 2 wherein the natural silk fibres constitute 1-50% by weight of the spun yarn.

7. A pile fabric according to claim 6 wherein the natural silk fibres constitute about 22% by weight of the spun yarn.

8. A pile fabric according to claim 4, 5, 6 or 7, wherein the lustrous fibres constitute between 20-50% by weight of the spun yarn.

9. A pile fabric according to claim 5 or any of claims 6 to 8 when dependent on claim 5, wherein the lustrous fibres comprise modal fibres.

10. A pile fabric according to claim 9 wherein the modal fibres have a dtex value of less than about 2 dtex.

11. A pile fabric according to any preceding claim wherein the blend of staple fibres are combed prior to spinning.

12. A pile fabric according to any preceding claims wherein the fabric is of a three pick terry weave construction.
